(19) United States
(12) Patent Application Publication
(10) Pub. No.: US 2026/0246118 A1
(43) Pub. Date: Aug. 20, 2026

(54) SECONDARY BATTERY

(71) Applicant: SK ON CO., LTD., Seoul (KR)

(72) Inventor: Seung Min LEE, Daejeon (KR)

(21) Appl. No.: 19/533,304

(22) Filed: Feb. 9, 2026

(30) Foreign Application Priority Data
Feb. 14, 2025 (KR) 10-2025-0019494

(51) Int. Cl. H01M 50/581; H01M 10/0583; H01M 50/105

(52) U.S. Cl. CPC H01M 50/581; H01M 10/0583; H01M 50/105

(57) ABSTRACT

A secondary battery is disclosed. According to the present disclosure, there is provided a secondary battery comprising an electrode assembly in which a positive electrode plate, a separator, and a negative electrode plate are stacked, a casing that accommodates the electrode assembly, a thermal switch that is disconnected from either the positive electrode plate or the negative electrode plate at a temperature less than or equal to a predetermined temperature and that conducts between the two electrode plates at a temperature greater than the predetermined temperature, and a resistor electrically connected to the thermal switch.

### CROSS-REFERENCE TO RELATED APPLICATION

The present application claims priority to and the benefit of Korean Patent Application No. 10-2025-0019494, filed on February 14, 2025 in the Korean Intellectual Property Office, the entire disclosure of which is incorporated herein by reference.

### TECHNICAL FIELD

Embodiments of the present disclosure relate to a secondary battery.

### BACKGROUND

A secondary battery is an energy storage device that can be charged and discharged through electrochemical reactions, and is widely used in various fields such as mobile devices, electric vehicles, aircraft, ships, and energy storage systems (ESSs). In particular, the demand for secondary batteries is continuously increasing as the electric vehicle market grows in accordance with strengthening environmental regulations in response to climate change and increasing energy costs due to rising oil prices.

Secondary batteries are classified into a pouch type, a prismatic type, a cylindrical type, or the like according to the package form, and each type is utilized in various applications depending on its characteristics. In general, prismatic and cylindrical secondary batteries are manufactured by overlapping and winding a positive electrode plate, a negative electrode plate, and a separator positioned therebetween to form a roll-type electrode assembly called a “jelly roll,” placing the roll-type electrode assembly in an aluminum metal case (prismatic) or a can (cylindrical), and injecting an electrolyte. In contrast, a pouch-type battery is completed by sequentially stacking a positive electrode plate, a separator, and a negative electrode plate to form a jelly roll, placing the jelly roll in an aluminum film-type pouch, sealing the aluminum film-type pouch, and injecting an electrolyte.

Pouch-type batteries are increasingly being used in fields requiring large amounts of energy, such as electric vehicles, due to their characteristics of greater freedom in package design, high energy density per unit volume, and ease of lightweighting. Prismatic batteries are mainly used in portable devices due to their high structural stability. Cylindrical batteries are seeing increasing demand in various industries, including electric vehicles, due to their standardized size and ease of mass production.

The above description is provided to help understand the technical background of the present disclosure. Therefore, the above description should not be construed as reducing, limiting, or restricting the technical scope of the present disclosure. In addition, nothing stated or suggested in the above description necessarily represents the related art. The above description may comprise content that does not correspond to the related art.

### SUMMARY

Some embodiments of the present disclosure may provide a secondary battery that may prevent thermal runaway in an emergency situation in which a temperature of the secondary battery increases to a temperature greater than or equal to a predetermined temperature.

In addition, some embodiments of the present disclosure may provide a secondary battery that may lower a temperature of the secondary battery in an emergency situation in which the temperature of the secondary battery increases to a temperature greater than or equal to a predetermined temperature.

Some embodiments of the present disclosure may be widely applied in green-technology fields such as electric vehicles, battery-charging stations, and solar and wind power generation systems that utilize batteries. Some embodiments of the present disclosure may be used in an eco-friendly electric vehicle, a hybrid vehicle, and the like to prevent climate change by suppressing air pollution and greenhouse gas emissions.

However, the technical challenges that embodiments of the present disclosure are intended to address are not necessarily limited to the technical challenges described above. Other technical challenges not described will be clearly understood by those of ordinary skill in the art to which the present disclosure pertains from other descriptions in the specification, comprising the detailed description.

According to one aspect of the present disclosure, there is provided a secondary battery comprising an electrode assembly in which a positive electrode plate, a separator, and a negative electrode plate are stacked, a casing that accommodates the electrode assembly, a thermal switch that is disconnected from either the positive electrode plate or the negative electrode plate at a temperature less than or equal to a predetermined temperature and that conducts between the two electrode plates at a temperature greater than the predetermined temperature, and a resistor electrically connected to the thermal switch.

In some embodiments, the thermal switch may be disposed centrally inside the electrode assembly.

In some embodiments, the thermal switch may be disposed close to either a positive electrode terminal or a negative electrode terminal inside the electrode assembly.

In some embodiments, the thermal switch may be disposed at a side surface of the electrode assembly.

In some embodiments, the secondary battery may further comprise a thermoelectric element that is disposed on any one of an upper surface, a lower surface, and a side surface of the electrode assembly, is electrically connected to the resistor, and absorbs heat of the electrode assembly when the thermal switch conducts between the two electrode plates.

In some embodiments, the resistor may be disposed in a folded-portion space of the casing in a width direction of the electrode assembly.

According to another aspect of the present disclosure, there is provided a secondary battery comprising an electrode assembly in which a positive electrode plate, a separator, and a negative electrode plate are stacked, a casing that accommodates the electrode assembly, a heat-sensing plate on which a plurality of thermal switches are arranged in a grid-like pattern, wherein each thermal switch is disconnected from either the positive electrode plate or the negative electrode plate at a temperature less than or equal to a predetermined temperature and conducts between the two electrode plates at a temperature greater than the predetermined temperature, and a resistor electrically connected to the thermal switches of the heat-sensing plate.

In some embodiments, the heat-sensing plate may be formed in the form of a porous plate.

According to still another aspect of the present disclosure, there is provided a secondary battery comprising an electrode assembly in which a positive electrode plate, a separator, and a negative electrode plate are stacked, a casing that accommodates the electrode assembly, a thermal switch that is disconnected from either the positive electrode plate or the negative electrode plate at a temperature less than or equal to a predetermined temperature and that conducts between the two electrode plates at a temperature greater than the predetermined temperature, a resistor electrically connected to the thermal switch, a phase-change material that coats the resistor, and a cover member that accommodates the phase-change material.

In some embodiments, the cover member may be a thermosetting resin pack or sheet.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings, in which:

FIG. 1 is a schematic perspective plan view of a secondary battery according to one embodiment of the present disclosure;

FIG. 2 is a side cross-sectional view of the secondary battery illustrated in FIG. 1;

FIG. 3 is a view illustrating the operation of a thermal switch illustrated in FIG. 1;

FIG. 4 is a perspective view of a secondary battery according to another embodiment of the present disclosure;

FIG. 5 is a perspective plan view of a secondary battery according to still another embodiment of the present disclosure;

FIG. 6 is a perspective plan view of a secondary battery according to yet another embodiment of the present disclosure;

FIG. 7 is a perspective view of a secondary battery according to yet another embodiment of the present disclosure;

FIG. 8 is a perspective view of a secondary battery according to yet another embodiment of the present disclosure;

FIG. 9 is a perspective plan view of a secondary battery according to yet another embodiment of the present disclosure; and

FIG. 10 is a flowchart of a method of applying a phase-change material to a resistor according to one embodiment of the present disclosure.

### DETAILED DESCRIPTION OF EXEMPLARY EMBODIMENTS

Hereinafter, embodiments of the present disclosure will be described with reference to the drawings. However, this is merely exemplary, and the present disclosure is not limited to the exemplified specific embodiments.

Hereinafter, the present disclosure will be described in detail with reference to the accompanying views. However, this is merely exemplary, and the present disclosure is not limited to the exemplified specific embodiments.

The following embodiments are provided to more fully and completely explain the technical ideas of the present disclosure to those of ordinary skill in the technical field to which the present disclosure pertains. Accordingly, the technical ideas of the present disclosure are not necessarily limited to the following embodiments. The present disclosure should be understood to broadly encompass various equivalents, substitutes, variations, and the like embodying the technical ideas described hereinafter.

The terms used in the description hereinafter are intended to more fully and completely describe certain embodiments in light of the above. Accordingly, the terms used in the description hereinafter should not be construed as reducing, limiting, or otherwise restricting the technical scope of the present disclosure.

Meanwhile, in the following views, the drawings of each component may be exaggerated or omitted for convenience of description and clarity.

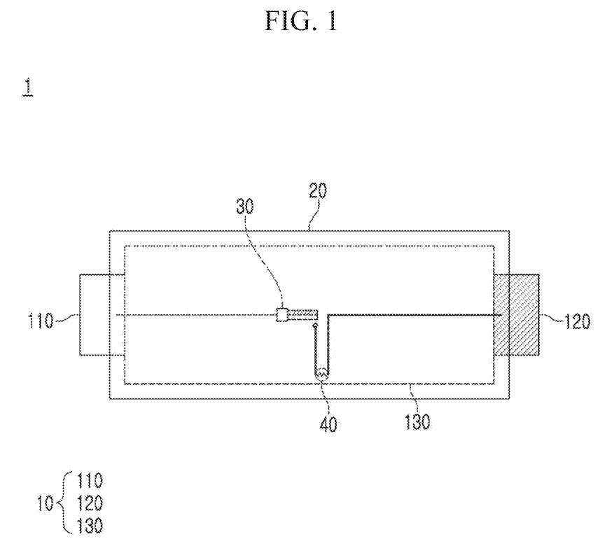

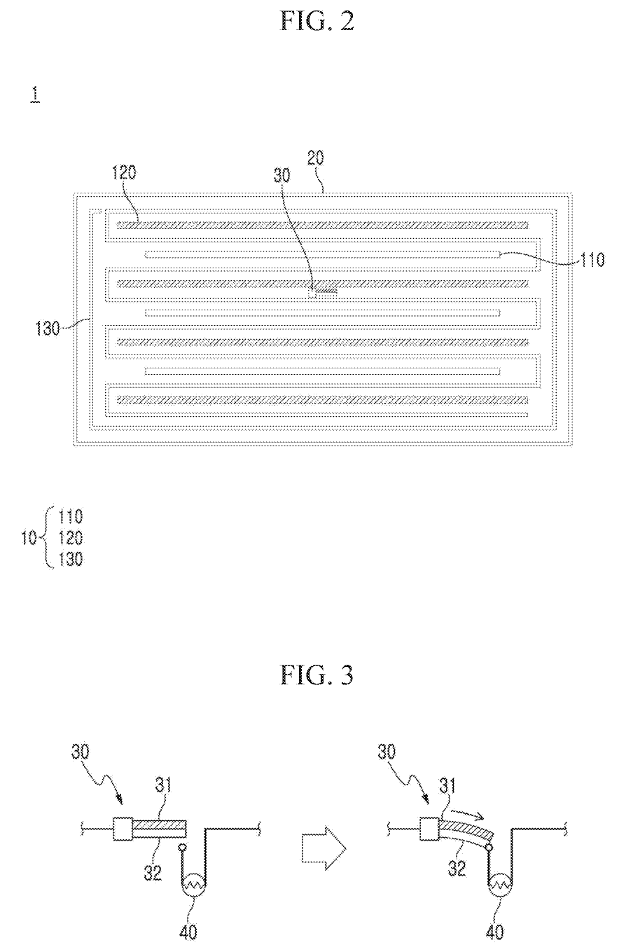

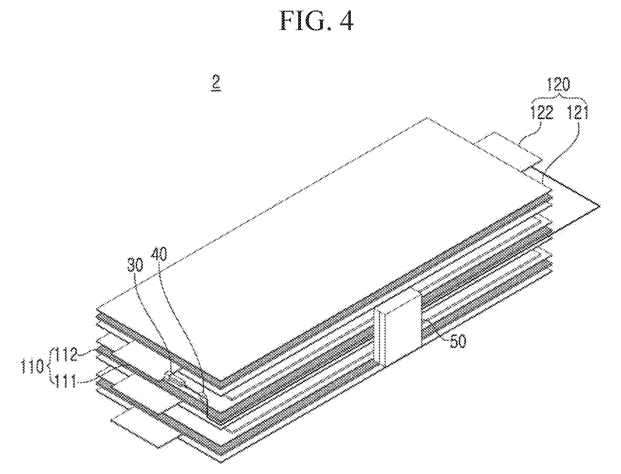

FIG. 1 is a schematic perspective plan view of a secondary battery according to one embodiment of the present disclosure, FIG. 2 is a side cross-sectional view of the secondary battery illustrated in FIG. 1, and FIG. 3 is a view illustrating the operation of a thermal switch illustrated in FIG. 1.

For reference, in the description hereinafter, a width direction may be defined as a direction (X-axis) across terminals of positive and negative electrodes protruding in different directions, a height direction may be defined as a direction (Y-axis) perpendicular to the width direction on a surface on which the terminals are formed, and a thickness direction may be defined as a direction (Z-axis) perpendicular to the width direction and the height direction.

Referring to FIGS. 1 to 3, in some embodiments, a secondary battery 1 comprises an electrode assembly 10 in which a positive electrode plate 110, a separator 130, and a negative electrode plate 120 are stacked, a casing 20 that accommodates the electrode assembly 10, a thermal switch 30 that is disconnected from either the positive electrode plate 110 or the negative electrode plate 120 at a temperature less than or equal to a predetermined temperature and that conducts between the two electrode plates at a temperature greater than the predetermined temperature, and a resistor 40 electrically connected to the thermal switch 30.

The electrode assembly 10 is formed by stacking the positive electrode plate 110, the separator 130, and the negative electrode plate 120, and is also referred to as a jelly roll. The positive electrode plate 110 may comprise an aluminum foil as a current collector, a positive electrode material (a positive electrode active material), a conductive material, and a binder, and the negative electrode plate 120 may comprise a copper foil as a current collector, a negative electrode material (a negative electrode active material), a conductive material, and a binder. The separator 130 may be configured to separate the positive electrode plate 110 and the negative electrode plate 120 to prevent electrical short circuits and allow ion flow. In some embodiments, the separator may comprise a porous polymer film or a porous nonwoven fabric. For example, the porous polymer film may comprise a polyolefin-based polymer such as an ethylene polymer, a propylene polymer, an ethylene/butene copolymer, an ethylene/hexene copolymer, and an ethylene/methacrylate copolymer. In addition, the porous nonwoven fabric may comprise high-melting-point glass fibers, polyethylene terephthalate fibers, or the like. The separator may comprise a ceramic-based material. For example, inorganic particles may be coated on the polymer film or dispersed in the polymer film to improve heat resistance. The separator may have a single-layer or multilayer structure comprising the above-described polymer film and/or nonwoven fabric. The electrode assembly 10 may be made by overlapping and winding the positive electrode plate 110, the separator 130, and the negative electrode plate 120 (winding type), may be made by alternately stacking individual positive electrode plates 110 and negative electrode plates 120 (stacking type), or may be a zigzag-folding type or a stack-folding type.

The casing 20 accommodates the electrode assembly 10 and serves to protect the electrode assembly 10 from external impact. The casing 20 may be in the shape of a pouch formed by bonding nylon and a cast polypropylene (CPP) film to aluminum foil, may be a prismatic aluminum metal case with rigid construction, or may be a cylindrical can.

The thermal switch 30 serves to be disconnected from either the positive electrode plate 110 or the negative electrode plate 120 at a temperature less than or equal to a predetermined temperature, and to conduct between the two electrode plates at a temperature greater than the predetermined temperature (see FIG. 3). The thermal switch 30 may be a bimetallic switch made of a metal 31 that expands well and a metal 32 that does not expand well. The metal 32 that does not expand well may be an alloy of nickel (Ni) and iron (Fe), and the metal 31 that expands well may be an alloy of nickel (Ni), manganese (Mn), and iron (Fe), an alloy of nickel (Ni), molybdenum (Mo), and iron (Fe), an alloy of nickel (Ni), manganese (Mn), and copper (Cu), or the like.

The resistor 40 is electrically connected to the thermal switch 30. The resistor 40 may be connected in series with the thermal switch 30. The resistor 40, which causes electrical resistance between two electrodes when the two electrodes are conducted by the thermal switch 30, may be a fixed resistor or may be a variable resistor. Additionally, the resistor 40 may be made of a positive temperature coefficient (PTC) metal material, which reduces the current magnitude as the resistance increases at high temperature. Thus, higher temperature may reduce heating of the resistor.

Meanwhile, as illustrated in FIGS. 1 and 2, in some embodiments, the thermal switch 30 may be disposed centrally inside the electrode assembly 10. In such a case, the temperature inside the electrode assembly 10 may be quickly measured and responded to, thereby preventing thermal runaway.

Additionally, although not illustrated, in some embodiments, the thermal switch 30 may be disposed on a side surface of the electrode assembly 10. Specifically, the thermal switch 30 may be disposed longitudinally on the side surface of the electrode assembly 10. The thermal switch 30 may be disposed on the side surface of the electrode assembly 10 to measure temperature without interfering with the flow of lithium ions.

FIG. 4 is a perspective view of a secondary battery according to another embodiment of the present disclosure. For convenience of description, the following description will focus on differences from the above-described embodiment.

As illustrated in FIG. 4, in some embodiments, a thermal switch 30 may be disposed close to either a positive electrode terminal 111 or a negative electrode terminal 122 inside an electrode assembly. The positive electrode terminal 111 and the negative electrode terminal 122 protrude from a positive electrode current collector 112 and a negative electrode current collector 121 and serve to electrically connect with the outside. When the thermal switch 30 is disposed close to the terminal, a temperature spike at the terminal due to high current density may be quickly detected, thereby activating the thermal switch. Accordingly, the SOC of the cell may be lowered, thereby preventing thermal runaway.

In some embodiments, the secondary battery may further comprise a thermoelectric element 50 that is disposed on any one of an upper surface, a lower surface, or a side surface of the electrode assembly 10, is electrically connected to the resistor 40, and absorbs heat of the electrode assembly when the thermal switch 30 conducts between the two electrode plates. The thermoelectric element 50 serves to absorb heat of the electrode assembly and discharge the heat to the opposite side when current flows due to a Peltier effect. As the thermoelectric element 50 operates, the SOC of the cell may be lowered, and the temperature inside the electrode assembly may also be lowered. While FIG. 4 illustrates that the thermoelectric element 50 is disposed on the side surface of the electrode assembly, it is not limited thereto, and the thermoelectric element 50 may also be disposed on the upper surface, the lower surface, or the like of the electrode assembly.

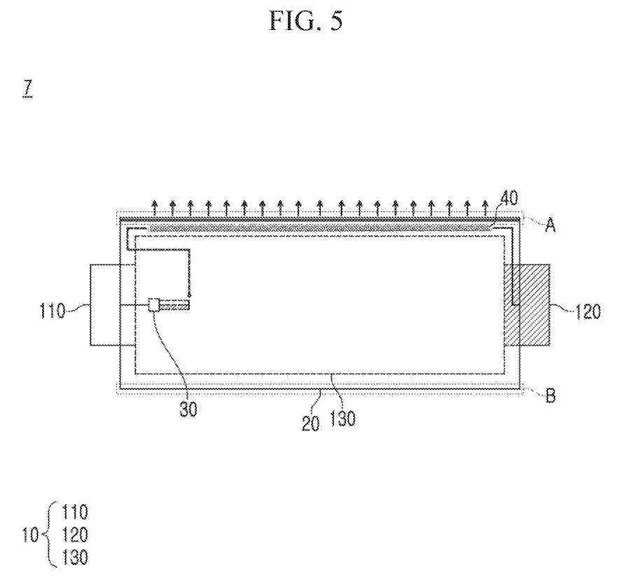

Further, in some embodiments, the resistor 40 may be disposed in a width direction of the electrode assembly 10. When the resistor 40 is disposed in the width direction of the electrode assembly in a folded portion (sealed portion) space of the casing (area “A” in FIG. 5), venting may be induced by heating the folded portion or melting the sealing portion. In addition, the resistor 40 may be disposed in a W- shaped portion (unsealed portion) space (area “B” in FIG. 5) opposite the sealing portion to facilitate cooling.

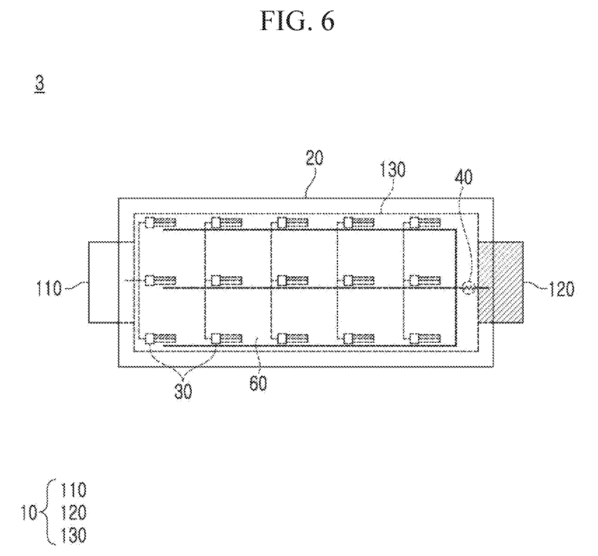

FIG. 6 is a perspective plan view of a secondary battery according to yet another embodiment of the present disclosure.

As illustrated in FIG. 6, in some embodiments, a secondary battery 3 may further comprise a heat-sensing plate 60 on which a plurality of thermal switches 30 are arranged in a grid-like pattern. The plurality of thermal switches 30 are arranged in the grid-like pattern, and thus temperatures at multiple locations may be measured and responded to. Therefore, when the temperature at a certain location rises to a temperature greater than or equal to a predetermined temperature, a short circuit may be quickly induced, thereby improving the stability of the secondary battery.

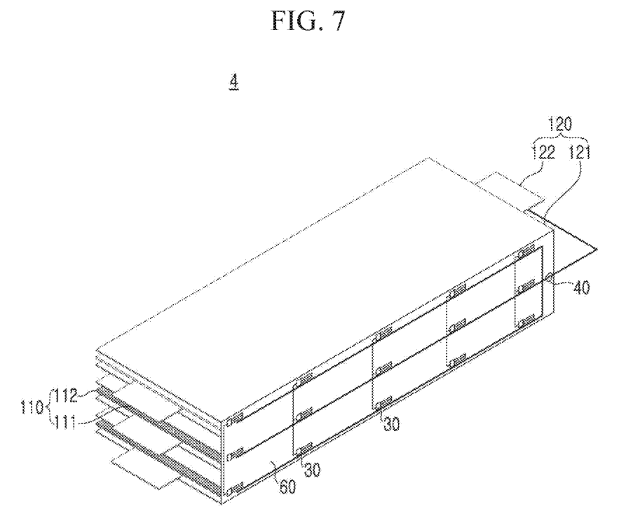

FIG. 7 is a perspective view of a secondary battery according to yet another embodiment of the present disclosure.

As illustrated in FIG. 7, in some embodiments, a heat-sensing plate 60 may be disposed on a side surface of the electrode assembly. By arranging the heat-sensing plate 60 on the side surface of the electrode assembly 10, temperatures at multiple locations may be measured without interfering with the flow of lithium ions.

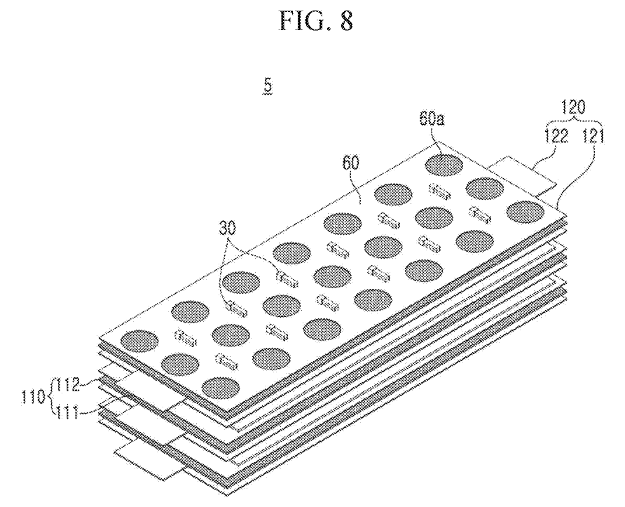

FIG. 8 is a perspective view of a secondary battery according to yet another embodiment of the present disclosure.

Referring to FIG. 8, in some embodiments, a heat-sensing plate 60 may be formed in the form of a porous plate. The heat-sensing plate 60A may be provided with a plurality of hollow holes 60a, thereby enabling temperatures at multiple areas to be measured while minimizing disturbance to the inflow of the electrolyte. Therefore, when the temperature at a specific area rises to a temperature greater than or equal to a predetermined temperature, a short circuit may be quickly induced, thereby improving the stability of the secondary battery.

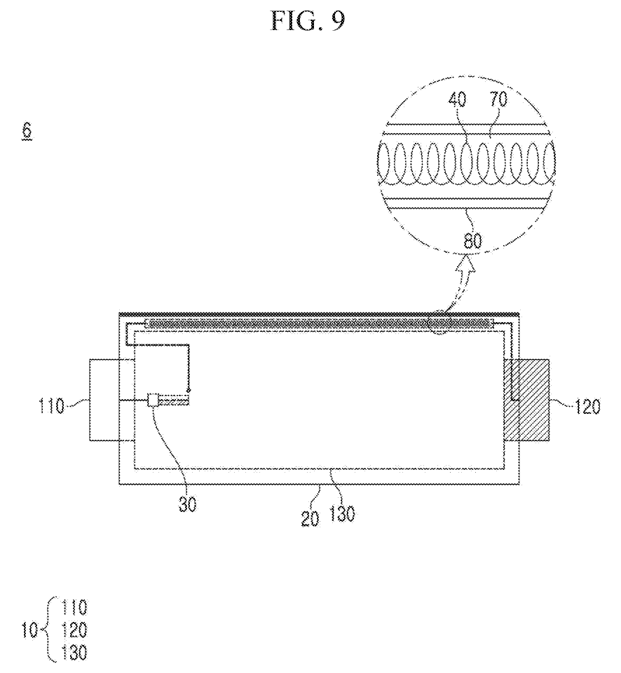

FIG. 9 is a perspective plan view of a secondary battery according to yet another embodiment of the present disclosure.

Referring to FIG. 9, in some embodiments, a secondary battery may comprise electrode assemblies 10, a casing 20, a thermal switch 30, a resistor 40, a phase-change material 70 coated on the resistor 40, and a cover member 80. The phase-change material 70 coated on the resistor 40 absorbs heat from the resistor 40 and prevents the temperature from rising. The phase-change material 70 may be a non-corrosive, stable, recyclable paraffin wax or an organic phase-change material such as fatty phases or esters having excellent phase-change performance.

The cover member 80 accommodates the phase-change material 70. The cover member 80 may be a pack or sheet of a thermosetting resin. More specifically, the cover member 80 may be an epoxy resin or phenolic resin having heat resistance, chemical resistance, and electrical insulating properties. The cover member 80, which is a thermosetting resin pack or sheet, ensures that, even when the phase-change material changes to a liquid phase due to heat generation during charging and discharging of the battery, a short circuit, heating from the outside, or the like, the phase-change material does not seep into the electrode assemblies 10 and remain therein. Accordingly, the phase-change material 70 is prevented from seeping into the electrode assemblies 10 and causing structural deformation such as expansion of the electrode assemblies 10.

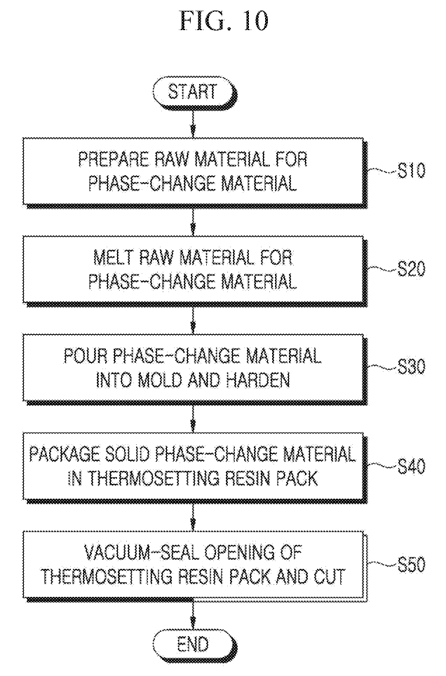

FIG. 10 is a flowchart of a method of applying a phase-change material to a resistor according to one embodiment of the present disclosure.

Referring to FIG. 10, one embodiment of the method of applying the phase-change material to the resistor will be described.

First, a raw material for the phase-change material is prepared (S10). The raw material for the phase-change material may be a paraffin-based material in a solid form. Specifically, the raw material may be a non-corrosive, stable, and recyclable paraffin wax, or an organic phase-change material such as fatty acids or esters having excellent phase-change performance.

Next, the raw material for the phase-change material is melted (S20). It may be melted at about 60 to 70 °C, and the specific melting temperature varies depending on the melting point of the phase-change material.

Next, the liquid phase-change material is poured into a mold of a predetermined shape together with the resistor 40 and then allowed to harden (S30).

Next, the shaped solid phase-change material is then packaged in a thermosetting resin pack (S40).

Here, the liquid phase-change material may also be poured directly into the thermosetting resin pack containing the resistor and allowed to harden, instead of being poured into the mold.

Next, an opening portion of the thermosetting resin pack is vacuum-sealed and then cut (S50).

Through the above method, the phase-change material may be easily applied to the resistor.

Embodiments of the present disclosure can prevent thermal runaway by reducing the state of charge (SOC) of a cell during an emergency situation in which the temperature of a battery cell increases above a predetermined temperature.

In addition, some embodiments of the present disclosure can prevent thermal runaway by reducing the temperature of a cell during an emergency situation in which the temperature of the cell increases above a predetermined temperature.

Also, some embodiments of the present disclosure enable an internal temperature of a cell to be quickly measured by positioning a thermal switch centrally inside an electrode assembly.

However, the technical effects achieved through the embodiments of the present disclosure are not necessarily limited to the effects described above. Other technical effects not described will be readily apparent to those skilled in the art from the detailed description and other descriptions in the specification.

The above description is merely an example of applying the principles of the present disclosure, and other configurations may be further comprised without departing from the scope of the present disclosure.

Although embodiments of the present disclosure have been described above, it will be understood by those of ordinary skill in the art that various modifications and changes may be made to the present disclosure by adding, altering, deleting, or supplementing components without departing from the technical spirit of the present disclosure as defined in the claims, and such modifications and changes are also comprised within the scope of the present disclosure.

What is claimed is:

1. A secondary battery comprising:
an electrode assembly in which a positive electrode plate, a separator, and a negative electrode plate are stacked;
a casing that accommodates the electrode assembly;
a thermal switch that is disconnected from either the positive electrode plate or the negative electrode plate at a temperature less than or equal to a predetermined temperature and that conducts between the two electrode plates at a temperature greater than the predetermined temperature; and
a resistor electrically connected to the thermal switch.

2. The secondary battery of claim 1, wherein the thermal switch is disposed close to either a positive electrode terminal or a negative electrode terminal inside the electrode assembly.

3. The secondary battery of claim 1, wherein the thermal switch is disposed at a side surface of the electrode assembly.

4. The secondary battery of claim 1, wherein the thermal switch is disposed centrally inside the electrode assembly.

5. The secondary battery of claim 1, further comprising a thermoelectric element that is disposed on any one of an upper surface, a lower surface, and a side surface of the electrode assembly, is electrically connected to the resistor, and absorbs heat of the electrode assembly when the thermal switch conducts between the two electrode plates.

6. The secondary battery of claim 1, wherein the resistor is disposed in a folded-portion space of the casing in a width direction of the electrode assembly.

7. A secondary battery comprising:
an electrode assembly in which a positive electrode plate, a separator, and a negative electrode plate are stacked;
a casing that accommodates the electrode assembly;
a heat-sensing plate on which a plurality of thermal switches are arranged in a grid-like pattern, wherein each thermal switch is disconnected from either the positive electrode plate or the negative electrode plate at a temperature less than or equal to a predetermined temperature and conducts between the two electrode plates at a temperature greater than the predetermined temperature; and
a resistor electrically connected to the thermal switches of the heat-sensing plate.

8. The secondary battery of claim 7, wherein the heat-sensing plate is formed in the form of a porous plate.

9. The secondary battery of claim 7, wherein the heat-sensing plate is disposed at a side surface of the electrode assembly.

10. A secondary battery comprising:
an electrode assembly in which a positive electrode plate, a separator, and a negative electrode plate are stacked;
a casing that accommodates the electrode assembly;
a thermal switch that is disconnected from either the positive electrode plate or the negative electrode plate at a temperature less than or equal to a predetermined temperature and that conducts between the two electrode plates at a temperature greater than the predetermined temperature;
a resistor electrically connected to the thermal switch;
a phase-change material that coats the resistor; and
a cover member that accommodates the phase-change material.

11. The secondary battery of claim 10, wherein the cover member is a thermosetting resin pack or sheet.

12. The secondary battery of claim 10, further comprising a thermoelectric element that is disposed on any one of an upper surface, a lower surface, and a side surface of the electrode assembly, is electrically connected to the resistor, and absorbs heat of the electrode assembly when the thermal switch conducts between the two electrode plates.

13. The secondary battery of claim 10, wherein the thermal switch is disposed close to either a positive electrode terminal or a negative electrode terminal inside the electrode assembly.

14. The secondary battery of claim 10, wherein the thermal switch is disposed at a side surface of the electrode assembly.

15. The secondary battery of claim 10, wherein the thermal switch is disposed centrally inside the electrode assembly.

16. The secondary battery of claim 10, wherein the resistor is disposed in a W-shaped space in a width direction of the electrode assembly.
